(19) United States
(12) Patent Application Publication
(10) Pub. No.: US 2007/0209299 A1
(43) Pub. Date: Sep. 13, 2007

(54) Extendable door jam

(76) Inventor: Richard El Etel, (US)

Correspondence Address: Woodrow Douglas English;County Square Professional Offices, Suite 101, 674 County Square Drive, Ventura, CA, 93003, US

(21) Appl. No.: 11/372,845

(22) Filed: Mar. 10, 2006

(51) Int. Cl. E06B 1/04

(52) U.S. Cl. 52/204.1

(57) ABSTRACT

An apparatus and method for providing a variable width door jam assembly for adjustment of a decorative door jam in an environment in which the frame of the door openings varies in width depending on materials and architecture.

### BACKGROUND OF THE INVENTION

1. Field of the Invention

The invention relates to construction materials, devices, and processes. In particular the invention discloses an expandable door jam easily adaptable to any width of door opening.

2. Description of the Prior Art

Prior art enclosed with narrative to follow.

### SUMMARY OF THE INVENTION

Building contractors often run into situations, especially when remodeling a building, where the contractor finds that the wall from which a door or window jam is to be hung is thicker than the door or window jam. In such situations, the contractor may finish facing of the over extended jam from the door by painting over the area exposed or preferably installing a specially cut element to fill in the over extended jam. The invention delineated herein discloses adaptable means and apparatus for expanding a door or even window jam to match the wall thickness in which the jam is situated. The apparatus consist of easily adaptable long and harrow veneer sheets of grained wood designed to match the existing jam or installed door/window therein. The sheet extensions can be conveniently cut in length to fit the existing jam. The veneer sheet then covers the over extended portion of the thick wall. By such means, the veneer sheets are placed along and over the extension of the wall from the end of the existing jam to the outer section of the wall. The veneer sheets are coupled at either side by a tongue and groove type interlocking and sealing manner, thus allowing the contractor/installer to customize a jam to a wall of varied thickness.

### BRIEF DESCRIPTION OF THE DRAWING

FIG. 1 depicts a perspective view of a portion of a doorway, door jam in which the expandable door jam invention is applied as illustrated in cross sections FIGS. 2 through 7. Variable sized door jams are further indicated by paired arrows A, B, and C (FIG. 6).

FIG. 2 illustrates a perspective view cross section of a narrow width A-A embodiment of the expandable door jam.

FIG. 3 is an exploded view of FIG. 2 delineating the four sections thereof.

FIG. 4 illustrates a perspective view cross section of a medium width B-B embodiment of the expandable door jam.

FIG. 4A is an alternate view of FIG. 4 depicting the variable width capability of the expandable door jam.

FIG. 5 is an exploded view of FIG. 4 delineating the four sections thereof.

FIG. 6 illustrates a perspective view cross section of a broad width C-C embodiment of the expandable door jam.

FIG. 6A is an alternate view of FIG. 6 depicting the variable width capability of the expandable door jam.

FIG. 7 is an exploded view of FIG. 6 delineating the four sections thereof.

FIG. 8 illustrates a perspective view cross section of the rear of the expandable door jam delineating a plurality of parallel grooves that inhibit typical bulging of the door jam.

### DETAILED DESCRIPTION OF A PREFERRED AND ENBELING EMBODIMENT

This application emanates from a Provisional Patent Application of the same inventor, Ser. No. 60/660,674, filed 10 Mar. 2005.

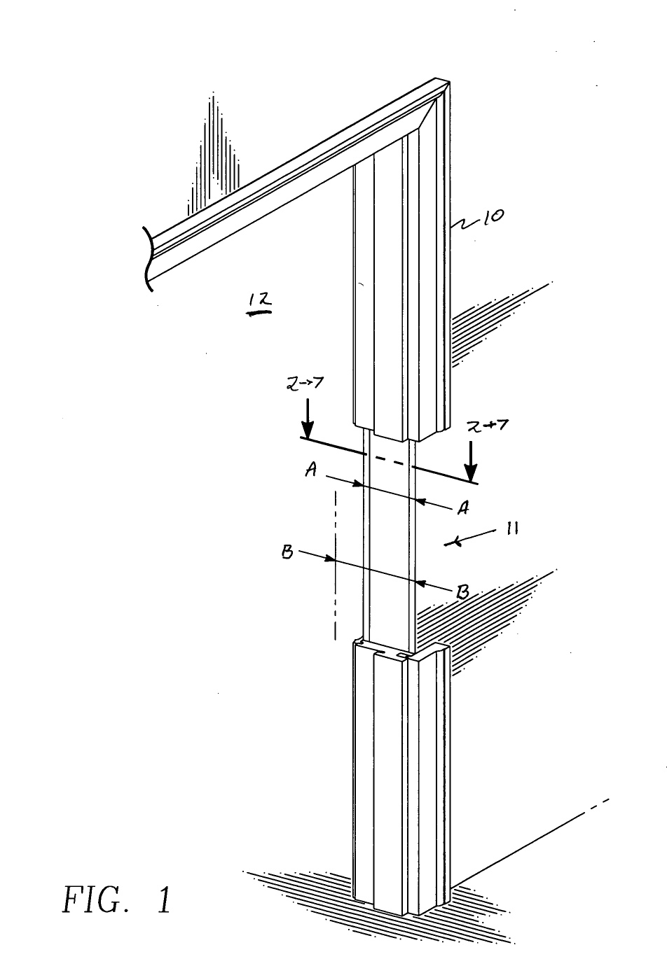

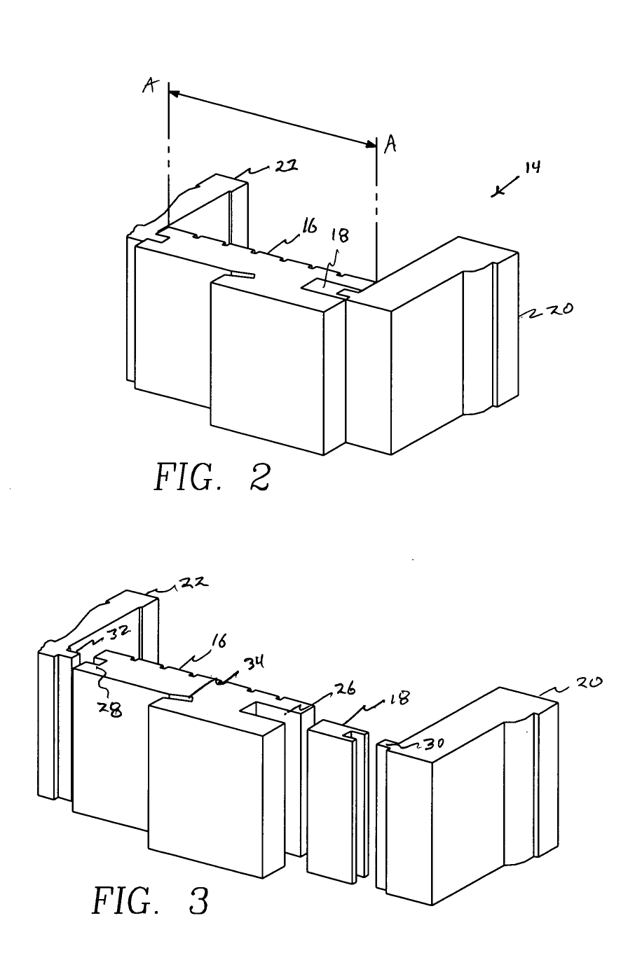

In this invention, applicant addresses the long felt need to be able to construct and conveniently finish a door jam from a variety of variable width door openings. Referring to FIG. 1, an overview of the invention concept is illustrated indicating a door jam 10, with a excised section 11 thereof, constructed around a door opening 12. As illustrated in FIG. 1, it is common for door openings and therefor door jams to vary in width from a few millimeters or fractions of an inch to several millimeters or inches, e.g. from A-A to B-B or wider as in C-C in FIG. 6. A cross section, 2-7, in FIG. 1 is clearly illustrated in all FIGS. 2 through 7.

FIGS. 2 and 3 describe the invention in a narrow form as a U shaped structure 14 consisting of four elements: a uniquely designed base member 16 into which may be inserted a housing element 18, which in turn receives an exterior door panel element 20 on an exterior side of base element 16. An interior door panel element 22 is similarly inserted into an opposing, interior side of base element 16.

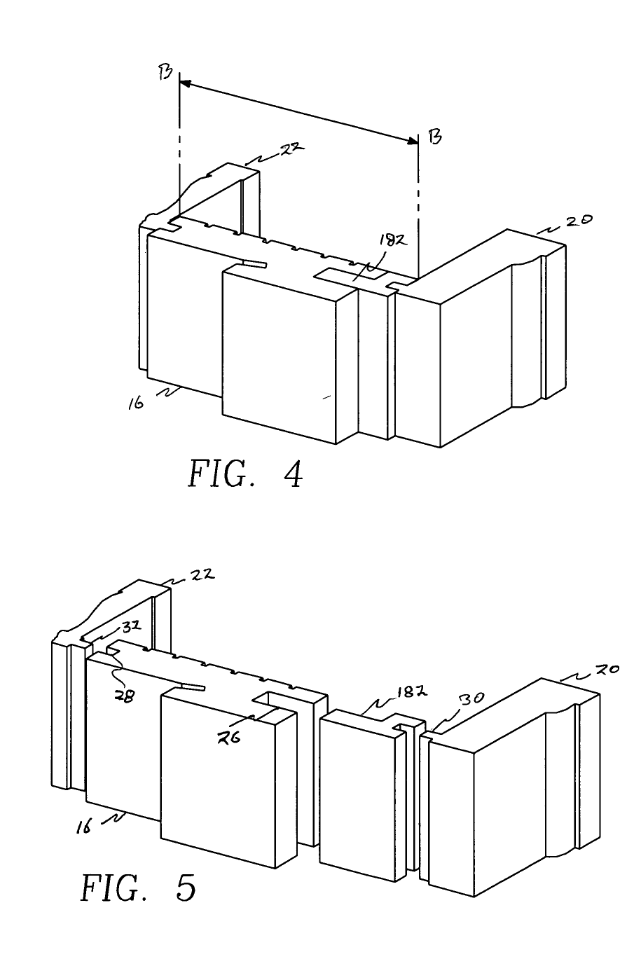

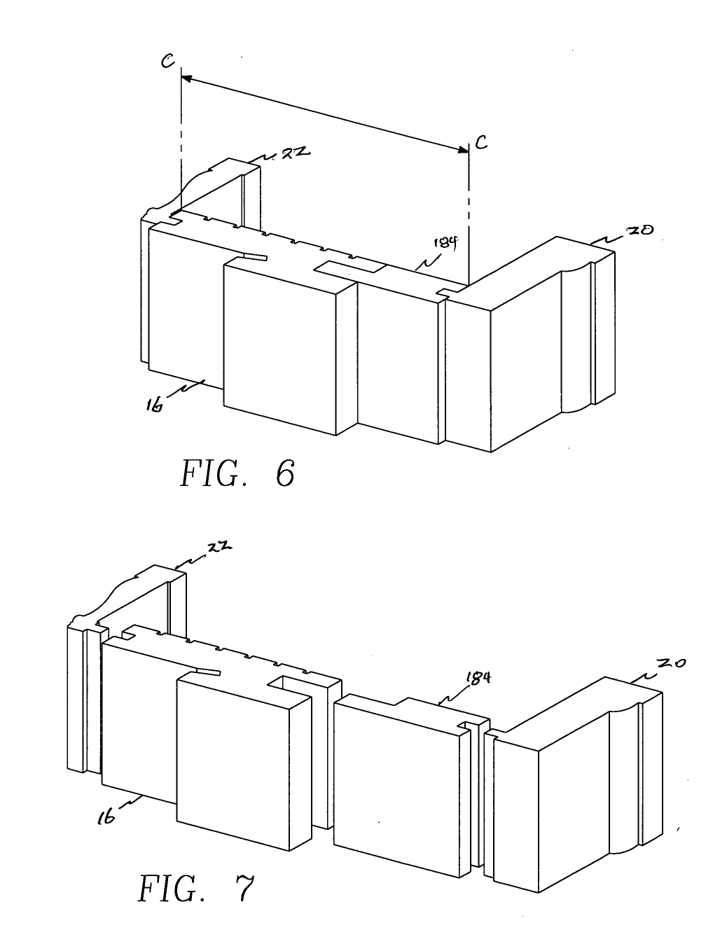

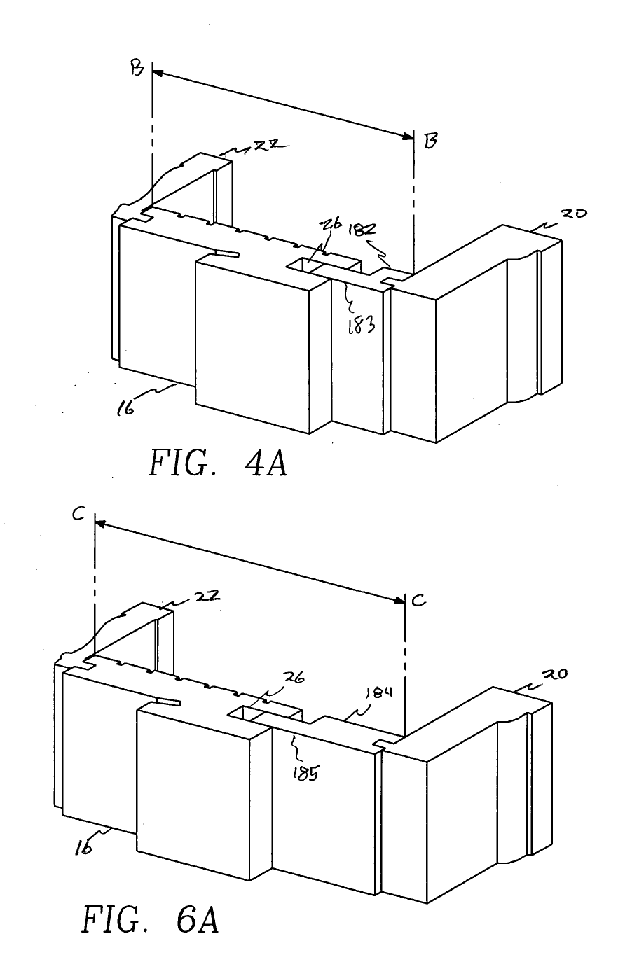

It will be observed that base element 16, exterior door panel element 20, and interior door panel element 22 do not vary in design and application in all FIGS. 1 through 8 variable embodiments of the invention. Housing element 18 of FIGS. 2 and 3 becomes an extender element 182 of FIGS. 4, 4A, and 5, and a broad extender element 184 of FIGS. 6, 6A, and 7.

Referring to FIGS. 4 and 5, all elements of the door jam invention are identical with the exception of extender element 182 and broad extender element 184 that insert into base element 16, thereby yielding an ability to variably extend the width of the door jam to accommodate a wider door jam opening.

Referring now to FIGS. 6 and 7, again all elements of this wider width, broad door jam are identical with the exception of a wide extender element 184 that inserts in like manner as in FIGS. 4 and 5 into base element 16 thereby yielding an ability to variably extend the width of the door jam to accommodate even wider door jam openings.

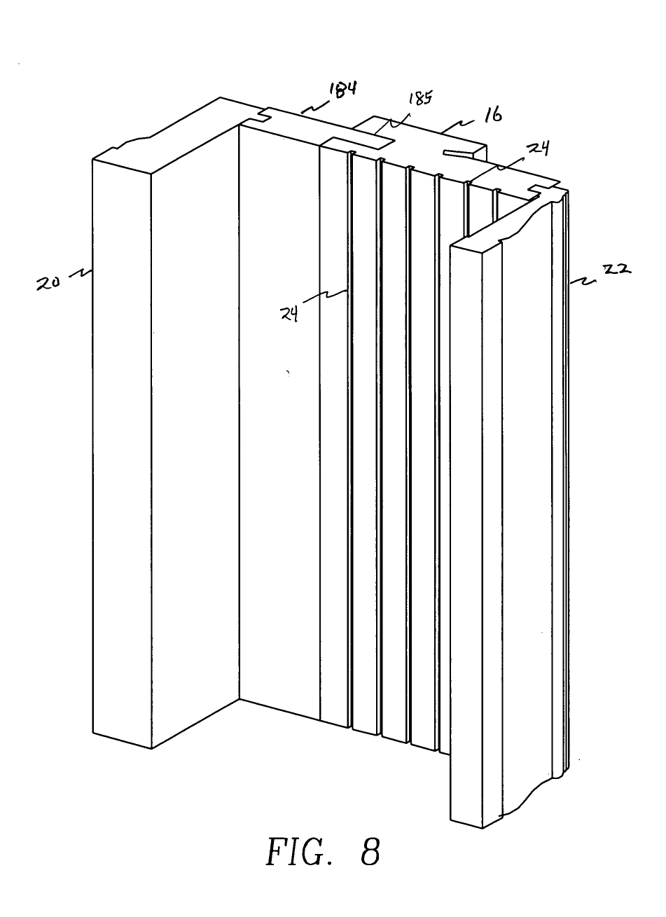

FIG. 8 is provided to illustrate the plurality of parallel grooves that inhibit if not prevent traditional bending or buckling of the door jam as water and weather cause over a period of time.

It will be observed that jam extender elements 182 and 184 in combination with a unique base element 16 demonstrate the novel improvement in the art and satisfy a long standing need to adapt door jams to be installed into door openings of a home or office that invariably vary in width from a millimeter or so to a several millimeters.

Referring now to FIGS. 3, 5, and 7, it will be observed that the door jam base element 16 consists of a rectangular member with female slots 26 and 28 on distal sides thereof for insertion of male ridges 30 and 32 and mounting of door jam exterior molding 20 and interior molding 22, respectively. At least one of said female slots is configured to be large enough for insertion therein of a door jam housing element 18, 182, and 184 of FIGS. 3, 5, and 7, respectively. It can be observed that element 18 is not actually an expanding element, but acts as an accommodating plug or housing insert into large slot 26 for adaptation of smaller ridge 30 of exterior molding 20. Again, it can be observed that base element 16 as well as moldings 20 and 22 are fixed in size, dimension, and configuration for all expandable embodiments of the invention illustrated in FIGS. 2, 4, and 6. The only change in each expandable embodiment in FIGS. 2, 4, and 6 is the expandable elements 182 and 184. It will be noted that an additional slot 34 is provided for conventional weather stripping for the full length of the door jam.

Referring now to FIGS. 4A and 6A, it can be observed that the variable width adjustment capability of the invention door jam is not limited to just the three embodiments illustrated in FIGS. 2, 4, and 6, because there would be an infinite number of adjustment settings by moving the male extender portion 183 and 185 of extender elements 182 and 184, respectively, may be slidably adjusted within female channel 26.

Although a detailed description of a preferred and enabling embodiment of the invention has been disclosed above, it will be understood that the extent of the invention concept will be limited by the claims appended hereto.

What is claimed is:

1. A variable width door jam assembly, comprising:
a base element;
an inside molding attached to an inside end of said base element;
an outside molding attached to an outside end of said base element; and
means disposed between at least one said moldings and said base element for incrementally increasing the width of said base element.
